(19) United States
(12) Patent Application Publication
(10) Pub. No.: US 2013/0066803 A1
(43) Pub. Date: Mar. 14, 2013

(54) SYSTEM AND METHODS FOR ANALYZING, COMPUTING AND DISPLAYING DEPTH OF MARKET VOLUME STRENGTH

(71) Applicant: Manish Pramod WORLIKAR, Clifton, NJ (US)

(72) Inventor: Manish Pramod WORLIKAR, Clifton, NJ (US)

(21) Appl. No.: 13/229,181

(22) Filed: Sep. 9, 2011

(51) Int. Cl. G06Q 40/00

(52) U.S. Cl. 705/36 R

(57) ABSTRACT

Systems and methods are described for analyzing, computing and displaying the depth of market (DOM) volume strength which may assist trader to forecast the movements of the financial instrument in a structured and systematic manner. According to various embodiments, the DOM volume of a financial instrument is measured. The DOM volume can include bid volume elements and/or ask volume elements corresponding to price levels for electronically traded financial vehicles such as stocks, futures, bonds, commodities, options and the like.

According to one example embodiment, an average of cumulative ask volume and/or cumulative bid volume is measured over a chart bar interval and the computed values are displayed on/below/above the chart for each bar. Higher value may imply strong support and/or resistance.

### FIELD OF THE INVENTION

This invention relates to improved methods apparatus concerning the trading of financial securities, more particularly to a method of processing, analyzing, computing and displaying the depth of market (DOM) volume data to assist traders in analyzing and forecasting the movement of financial instrument.

### BACKGROUND OF THE INVENTION

In the field of financial trading, trading of financial instruments (e.g., stocks, futures, options, currency, or, etc.) is typically done today through an electronic exchange, rather than on the historical exchange floor. In electronic trading anyone with a computer can trade directly with the exchange. Via a trader's computer that accesses the exchange via a network, the trader can obtain real-time or historical financial data, place trade orders, perform a wide range of financial analyses, and more.

Traders engaged in electronic trading must be able to process and absorb numerous market information made available to them while trading such as specialized graphical user interfaces to obtain depth of market, market price data, execute orders and monitor status of different market conditions. Market exchange is a fast-paced, fluid environment where price, quantity, DOM, and other market criteria constantly fluctuate within a very short period of time. The better the evaluation, organization and representation of information in an electronic trading application (charts such as candlesticks and/or Technical analysis such as Moving averages of closes and more) can more or less improve the trader's ability to make quick and informed decisions and yield significant returns in the market.

Technical analysis uses a variety of displays and statistical calculations to monitor trading prices and trading volumes, usually for fixed time intervals, to assist traders who try to make profits based on the short-term swings of the market. Traders who depend on technical analysis range from market makers, who are continuously trading and making buy and sell orders, to day traders, who try to take advantage of minute or hourly or daily price changes to make a profit, to slightly longer-term investors who track stock price and trading volume fluctuations over a period of a few days or weeks and trade on the basis of recent trends.

Technical analysis focuses on patterns that appear on the historical price charts of a financial instrument in the belief that historical price patterns may repeat, or that recent price trends may help predict the future price of a financial instrument. Technical analysis, as generally practiced, is based on a review of historical time series data, such as a series of daily/minute based closing prices for a financial instrument. A number of known statistics have been derived from the processing of time series data, and trading systems have been developed to produce and display them. These statistics include moving averages, stochastic oscillators, along with specialized quantitative studies such as Bollinger bands, Fibonacci curves, and candlestick charts. Time series data is also summarily displayed in various fixed time intervals, from tens of seconds to minutes, hours, days, months or years.

Traders present on an exchange floor benefit from the ability to observe the number and price of prospective transactions (i.e., bids to buy or ask to sell) by other participants. This information is sometimes referred to as order book or depth of market (DOM) information, and can assist a trader in discerning market trends. Traders present on an exchange floor may also observe many visual and auditory cues relating to the behavior of market participants. The increased use of all electronic market exchanges, however, is pushing market makers off of exchange floors and these previously available visual and auditory cues need to be now gathered electronically from DOM creating a need for new improved analysis to determine markets supply and demand.

Present trading systems and methods contain numerous ways of displaying and analyzing the DOM also may be referred as “market supply and demand” for a particular trading vehicle such as a commodity.

One approach to displaying DOM information for example, a software package sold under the name “TradeStation” displays a DOM window, an example of which is shown in FIG. 2 a tabular format for DOM data with three columns. First column showing a plurality of bids corresponding to the prices on the second column, a third column showing a plurality of asks corresponding to the prices on the second column and as the market conditions changed a new value for bid/ask volume is replaced at the corresponding price level losing the previous value. However, the DOM information in this system is extremely difficult for a trader to visually focus and evaluate on continuous bases as the underline market changes at a very fast pace even for moderately liquid markets.

U.S. patent application, Pub No US 2008/0086401 A1, application Ser. No 11/828,264, entitled “CHARTING WITH DEPTH OF MARKET VOLUME FLOW” computes DOM volume flow by taking DOM volume snapshots of bid and/or ask order volume at each price level, at starting and ending time intervals, compute DOM volume differences for bid and/or ask order volume, for each corresponding DOM price levels then compute the weighted sum of DOM volume differences for Ask and/or bid order volumes. This system fails to capture the magnitude (value) of DOM Volume. For example 50−45=5 and also 500−495=5, but 500 is clearly 10 times larger than 50. These high values may assist traders in identifying dynamic support and resistance levels/zones in the financial instrument which may result in making profit in the market. In addition this system fails to capture DOM changes on continuous basis instead relies on snapshots.

Accordingly there is a need for an improved DOM (can also be referred as supply and demand) analyzes that addresses the limitations of existing systems/methods and effectively assist traders regarding current market conditions which may help trader to take rapid and more informed trading decisions to make profit in the market. Other needs will become apparent upon reading the following description, taken in conjunction with the drawings.

### BRIEF SUMMARY OF INVENTION

It is therefore an object of the present invention to provide an arrangement for analyzing, computing and displaying the DOM volume strength that avoids the aforementioned disadvantages of prior-art systems

The present system and methods are appropriate for use in an electronic trading environment, and particularly when market depth information is provided by the exchange in its data feed.

Systems and methods are described for measuring DOM volume strength. According to various embodiments, the DOM volume of a financial instrument is monitored. The DOM volume can include bid volume elements and/or ask volume elements corresponding to price levels for the financial instrument that are provided by electronic exchange. DOM volume strength may then be computed, according to some embodiments, by evaluating specific functions of one or more elements of the DOM volume. Then, indicators of the computed DOM volume strength values may be displayed on a chart.

According to various embodiments, the DOM volume strength study chart includes indicators of average cumulative ask volume and average cumulative bid volume over a determined time period. In one embodiment the indicator can be configurable and alert trader if certain specified threshold above or below for DOM volume strength is reached during the time period. In one embodiment the determined time period may be fixed, while in other embodiments the determined time period may be dynamic.

In some embodiments, the indicators can indicate current support and resistance levels/zones in the trading instrument.

In some embodiments, a plurality of bid/ask candlestick bars may be displayed across the chart with DOM volume strength values illustrated with indicators. In one embodiment, the indicators are arrows above and/or below each of the bars. For example, the arrows above the bars may be used to indicate ask DOM volume strength reached a specified threshold, while arrows below the bars represent bid DOM volume strength reached a specified threshold during the bar time interval. The direction that the arrows point indicates whether the threshold above or below was reached for DOM volume strength during the time period.

In some embodiments, the arrows can be colored certain colors to further improve visual abilities. In some embodiments the width of the candlestick bars may vary based on the DOM volume strength indicator for example the candlestick bar can be vertically divided into two parts, left part can indicate bid strength and the right part can indicate the ask strength or vice versa.

Typically in commercial applications available the total volume (ask and bid volume combined) information is conveyed using the bar width for most known types of bars on charts for example candlesticks, range much more.

As per the suggested embodiment, by vertically dividing the bar, it can continue to convey correctly all the typical open, high, low and close bar properties along with appropriate color coding based on open is greater or less then close, to the user as well as based on the left/right width convey appropriate ask/bid DOM volume strength.

According to various embodiments, the volume strength in bid DOM volume and ask DOM volume over a determined time period may be determined by a computing or evaluating specific functions on the DOM volume.

In one embodiment, the function of DOM volume strength is average of weighted cumulative total of DOM volumes on either side of the inside market during the time period. Defining weight for each price level on either side may be optional.

In one embodiment, the function of DOM volume strength is to alert trader if a certain trader specified threshold above or below for DOM volume strength is reached during the time period. Some electronic exchanges only provide information to a limited number of DOM price levels on either side of the market (e.g., ten values on either side). In one embodiment, the weighted cumulative total defaults to using the five DOM price levels on either side of the inside market for the DOM volume strength calculations.

In some embodiments, the DOM volume strength values may be displayed as an overlay on a candlestick charts. The display of the DOM volume strength may include graphical indicators.
For example, ask DOM volume strength arrows above the bar point up when higher threshold in ask DOM volume strength is reached;
ask DOM volume strength arrows above the bar point down when lower threshold in ask DOM volume strength is reached;
bid DOM volume strength arrows below the bar point up when higher threshold in bid DOM volume strength is reached;
bid DOM volume strength arrows below the bar point down when lower threshold in bid DOM volume strength is reached.

In some embodiments, ask and/or bid DOM volume strength values may be displayed either concurrently with or independent of candlesticks charts and/or trading interface for example line chart consisting of two line graphs one representing bid volume strength and other ask volume strength.

In some embodiments, ask and/or bid DOM volume strength values may be displayed as histogram or line graphs showing maximum strength reached for each during the time period.

While many embodiments are disclosed, other embodiments, advantages and features of the present invention will become apparent to one with skill in the art upon examination of the following detailed description, drawings and examples. It is intended that all such features and advantages be included within the scope of the present invention, and be protected by the accompanying claims.

It should be appreciated that the above and following descriptions address a financial instrument or vehicle that is being traded and are intended to cover all types of instruments or vehicles that may be traded on an electronic trading exchange and not any specific bond, stock, option, commodity, stock or futures index contract, etc. It should be understood, however, that the detailed description and specific examples, while indicating preferred embodiments of the present invention, are given by way of illustration and not limitation.

### BRIEF DESCRIPTION OF THE DRAWINGS

Many aspects of the present embodiments may be better understood with reference to the following drawings. The components in the drawings are not necessarily to scale, emphasis instead being placed upon illustrating example embodiments.

FIG. 1 illustrates a typical electronic exchange communication with clients.

FIG. 2 illustrates prior art depth of market display.

FIG. 3 illustrates a innovative way of displaying both ask and bid volume information on bar charts such as candlesticks and more according to one embodiment of the present invention.

FIG. 4 illustrates cumulative calculation of ask and bid DOM volumes used further to measure DOM volume strength according to one embodiment of the present invention.

FIG. 5 illustrates a DOM volume strength calculation example according to one embodiment of the present invention.

FIG. 6 illustrates exemplary user interface that allow user to set up weight parameters for use in measuring DOM volume strength according to one embodiment of the present invention.

FIG. 7 illustrates weighted cumulative calculation of ask and bid DOM volumes according to one embodiment of the present invention.

FIG. 8 illustrates exemplary user interface that allow user to select the available DOM levels for use in measuring DOM volume strength according to one embodiment of the present invention.

FIG. 9.1 illustrates exemplary user interface that allow user to select/unselect alerts if the user configurable min and/or max percent rank of DOM volume strength are reached according to one embodiment of the present invention.

FIG. 9.2 illustrates exemplary user interface that allow user to select/unselect alerts if the user configurable min and/or max absolute values of DOM volume strength are reached according to one embodiment of the present invention.

FIG. 10 illustrates an exemplary DOM volume strength indicator in correspondence with candlestick chart, in accordance with various embodiments of the present invention.

FIG. 11 is a flowchart illustrating an exemplary algorithm for calculating the DOM volume strength values for a current bar in accordance with some embodiments of the present invention.

FIG. 12 illustrates an algorithm for calculating the DOM volume strength values in accordance with an alternative exemplary embodiment. In this particular embodiment, there is no end of bar signal only start of the bar signal is available.

### DETAILED DESCRIPTION OF THE INVENTION

The present system and method are appropriate for use in an electronic trading environment, and particularly when market depth is provided by the exchange in its data feed.

An advantage of using the present system is it measures a true strength of DOM volume on continuous basis instead of snapshots at time intervals.

A still further advantage is that the present system is a new way of displaying the ask and bid volume strength on most of the available bar charts types for example candlesticks, bar chart and more. Yet another advantage is that the present system is its new way of computation which processes markets supply and demand via DOM and identifies support and resistance levels/zones.

Other features and advantages will become apparent to one with skill in the art upon examination of the following drawings and examples. It is intended that all such features and advantages be included within the scope of the present invention, and be protected by the accompanying claims. Further, it will be appreciated by those of skill in the art that the preferred system may be provided as methods or computer readable program means.

For the purposes of a clearer understanding of the matters discussed herein, certain terms used herein are, for convenience only, described below, along with a non-limiting, representative description of the meaning that may be attributable to such terms.

Inside market price or Inside market—The price level that lies between the highest price bid and the lowest ask price in a market for a trading vehicle. The inside market price may or may not be a valid tradable market price.

Depth of market or DOM or DOM volume or Order book—tabular format with three columns. First column showing a plurality of bids corresponding to the prices on the second column, a third column showing a plurality of asks corresponding to the prices on the second column.

DOM levels—generally refers to number of bid and ask volume data on DOM.

Financial instrument or security—generally refers to anything that can either bought sold by specifying a price and a quantity. Examples of financial instruments include, but are not limited to., stocks, futures, bonds, commodity futures, mutual funds, exchange traded funds (ETF's), stock options, commodity options and the like.

trader or user—the entity using the present systems and methods, anyone trading a financial instrument.

Price bar or bar or candle or data bar or data point—generally refers to the graphical representation of data entity for a fixed or dynamic time period that includes four price values an open price which is the first price registered; a high price, which is the highest price registered for the discrete duration of the bar; a low price, which is the lowest price registered for the discrete duration of the bar; and a close price, which is the last price registered for the discrete duration of the bar.

ask DOM volume or ask DOM volume level(s)—generally refers to volumes (number of contracts or shares) at ask side of DOM corresponding to price levels.

Cumulative ask DOM—generally refers to the total of all the volumes (number of contracts or shares) at ask side of DOM corresponding to price levels.

bid DOM volume or bid DOM volume level(s)—generally refers to volumes (number of contracts or shares) at bid side of DOM corresponding to price levels.

Cumulative bid DOM—generally refers to the total of all the volumes (number of contracts or shares) at bid side of DOM corresponding to price levels.

Overlay—refers to graphical display of one data set in the same window pane as another data set or other data sets.

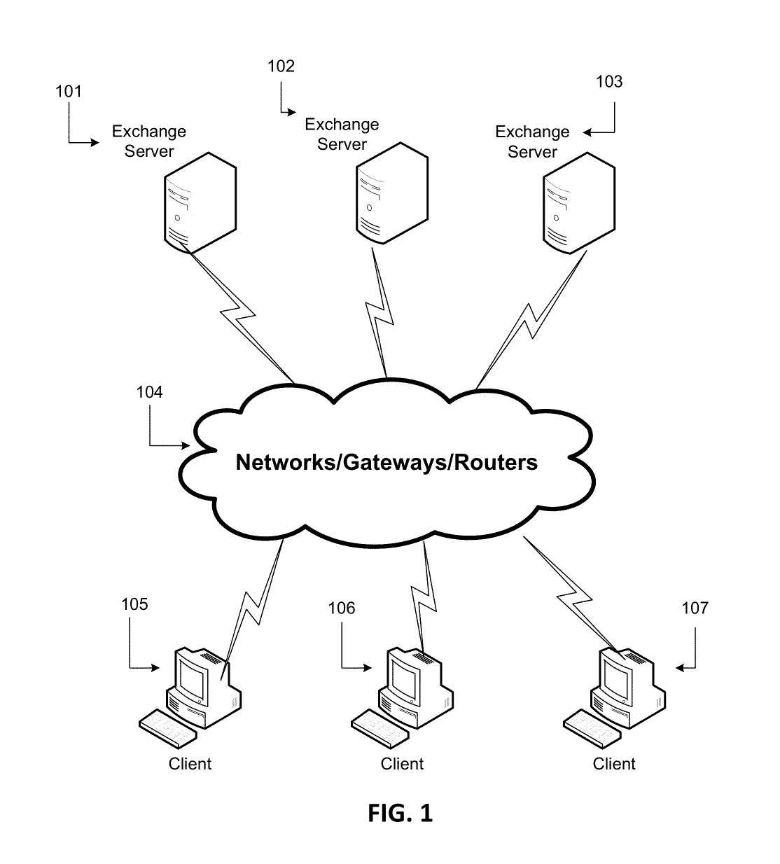

The system can be configured to access a single or multiple exchanges simultaneously. Connection of the system of the present invention with multiple exchanges is illustrated in FIG. 1. This figure shows multiple exchanges servers 101-103 connected via a series of networks, gateways and/or routers 104 to multiple clients 105-107.

The exchange sends the DOM, price, traded volume, order, fill and more information to each trader/client on the exchange. The present invention processes DOM information. How far into the market depth the present invention can display depends on how much of the market depth the exchange provides. Some exchanges supply an infinite market depth, while others provide no market depth or only a few orders away from the inside market. The user of the present invention can also chose how far into the market depth to use in computations.

In the preferred embodiment, the present invention is implemented on a computer or electronic terminal. The computer is able to communicate either directly or indirectly (using intermediate devices/networks) with the exchange to receive and transmit market information. It is envisioned that the system of the present invention can be implemented on any existing or future terminal or device with the processing capability to perform the functions described herein. The scope of the present invention is not limited by the type of terminal or device used.

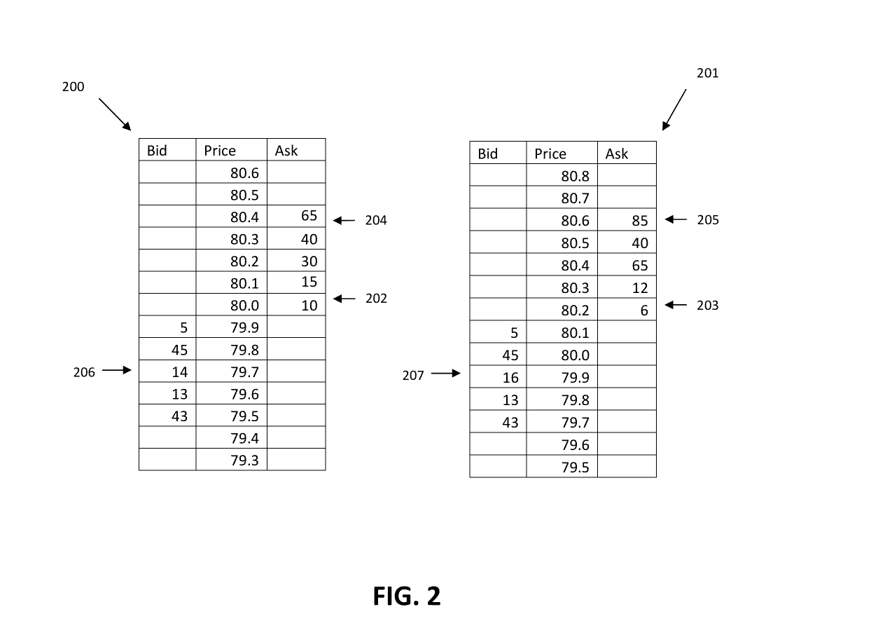

FIG. 2 shows prior art, a typical depth of market as displayed by many commercial charting applications as a tabular format, in which bids, price and asks are displayed in separate vertical columns. First column showing a plurality of bids corresponding to the prices on the second column, a third column showing a plurality of asks corresponding to the prices on the second column. Any or all DOM ask and/or bid volumes may change over a period of time. Even if there is no trade executed still any/all the DOM volumes are subject to change.

For example display 200 shows DOM at a certain time T1 and 201 shows DOM at a later time T2. For illustration purpose let's say at time T1, 202 had a value of 10 which is now changed to a new value of 6 at 203 and similarly value of 65 at 204 is now changed to 85 at 205 and value of 14 at 206 is now changed to value 16 at 207.

Typically in a trading market the DOM volumes change at a faster rate than even a blink of an eye.

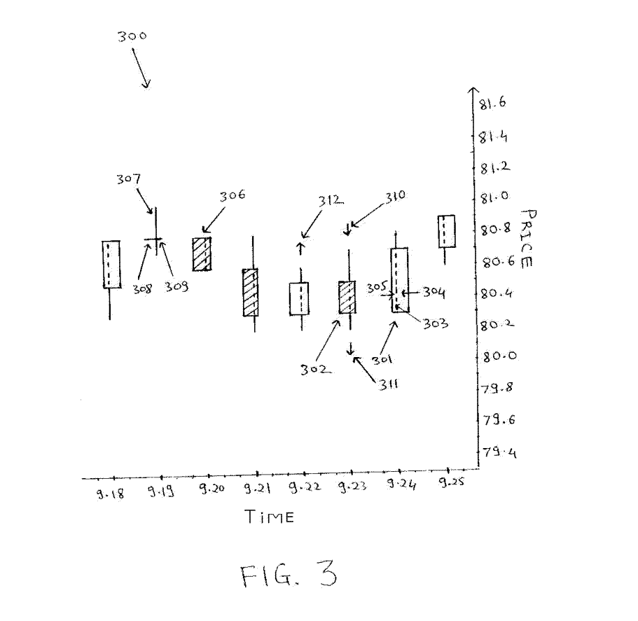

FIG. 3 illustrates a typical candlestick chart for a financial instrument with a key difference of vertically dividing each candle (bar) to accurately display the bid and ask volume strength for each bar.

A candlestick chart is a style of bar-chart used primarily to describe price movements of a financial instrument over time. Candlesticks are usually composed of the body (black or white), and an upper and a lower shadow (wick): the area between the open and the close is called the real body, price excursions above and below the real body are called shadows. The wick illustrates the highest and lowest traded prices of a security during the time interval represented. The body illustrates the opening and closing trades. If the security closed higher than it opened, the body is white or unfilled, with the opening price at the bottom of the body and the closing price at the top of the body. If the security closed lower than it opened, the body is black, with the opening price at the top of the body and the closing price at the bottom of the body. A candlestick need not have either a body or a wick. To better highlight price movements, modern candlestick charts often replace the black or white of the candlestick body with colors such as red (for a lower closing) and blue or green (for a higher closing). Any combination or colors and/or shades and/or intensities and/or patterns such as crosshatching could be used but is not limited to.

300 is a candlestick chart with time as x (horizontal) axis and price as y (vertical) axis.

301 is a candlestick bar where security closed higher than the open for a given time interval of the bar and is depicted as an example with a white body, also the low in this bar is same as the open and high of the bar is higher than the close as depicted by a wick at the top. Similarly 302 is a candlestick bar where security closed below the open for a given time interval of the bar and is depicted as an example with a crosshatch, also this candle as different prices for high, low, open and close as depicted by 2 wicks at the top and bottom of the candle bar. 303 is a vertical divider marker in this example it is displayed as a dotted vertical line in the body of the candle bar. This marker can be of any style, color and/or shape as long as it clearly displays the candle bar divided in two vertical sections. Either one of the left or right side can be used to display variable width ask or bid volume strength, in this example the right side width from the vertical divider shows ask volume strength as shown by 304 and left side width as bid volume strength as shown by 305. Here 303 acts like a divider between 304 and 305. 304 and 305 can have variable width based on ask and bid volume strength respectively.

According to one embodiment, an end user, such as a trader, may be able to set volume thresholds that are used to determine the width of the bars. The volume thresholds may be expressed as absolute values, as a percent rank relative to historical volume values, or as percentages of a base volume where the base volume may be expressed as an absolute value or be algorithmically determined, for example, by calculating a median or a moving average of the historical volume values. Other algorithms may be used to determine the base volume. Because the volume thresholds can be quite different for different trading sessions, data may be segregated by session when using the historical data to determine the relative rank or the base volume threshold.

306 is a bar where there no wick which means and is crosshatched which means the high is equal to open and close is equal to close.

307 is a bar where there is no body and wick on both ends which means both open and close are equal and high is above and low is below them. In this case the vertical wick divides the bar in two sections 308 and 309. 308 width in this example indicates the bid volume strength and 309 width in this example indicates the ask volume strength.

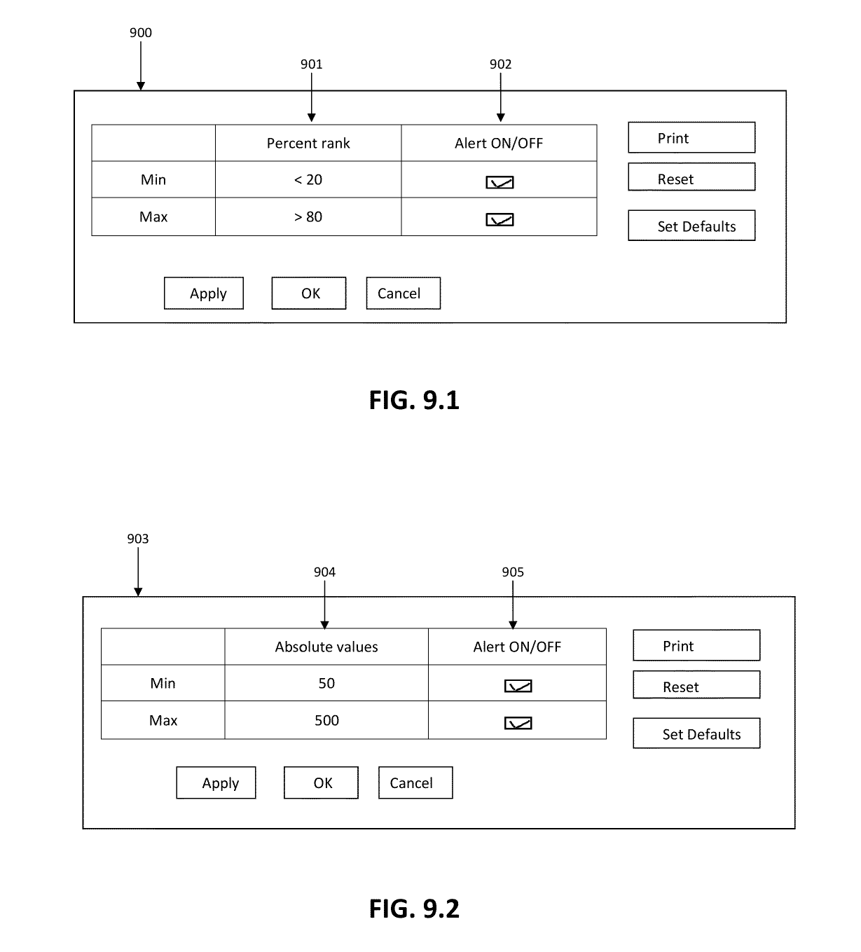

In addition 310 arrow down indicates that ask volume lower threshold was reached in this bar and 311 arrow down indicates that bid volume lower threshold was reached in this bar and 312 arrow up indicates that ask volume higher threshold was reached in this bar. Volume threshold setup is explained in FIG. 9.1 and FIG. 9.2

Many commercially available charting applications have variable width bars but the width is based on total volume of the bar these applications do not display ask and bid volumes. This present invention not only shows the total volume (total width) but also vertically divides the bid and ask volumes.

U.S. patent application, Pub No US 2008/0086401 A1, application Ser. No 11/828,264, entitled “CHARTING WITH DEPTH OF MARKET VOLUME FLOW”, the contents of which are fully incorporated by reference herein, describes one method of displaying ask and bid volume but has several limitations. It divides the bar horizontally and identifies the upper and lower sections of the bar body for depicting ask and bid volume. Some bars such as 307 do not have body so there is no way to depict ask and bid volumes in these cases, also some bars may have very small body which will make it very difficult for the user to identify ask and bid volumes inside that small body. Also the inherent color coding of a candlestick bar body for example green body for higher close than open and red body for lower close than open cannot be displayed if body is used to show ask and bid volume.

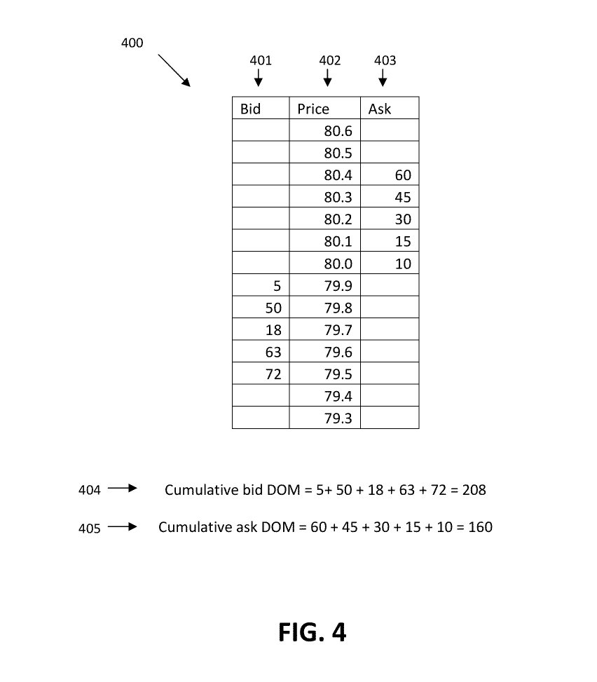

FIG. 4 illustrates how ask and bid DOM cumulative values are calculated. In this example five DOM levels of each ask and bid are displayed. Typically numbers of DOM levels vary by exchange and instrument.

400 display a typical DOM in a tabular format with three columns. 401 is the bid column, 402 is a price column and 403 is ask (offer) column of a financial instrument. 401 displays bid DOM volumes at each corresponding price levels for example bid volume of 5 is at 79.9 price and bid volume of 50 is at 79.8 price and so on and similarly ask volume of 10 is at 80.0 price and ask volume of 15 is at 80.1 price and so on. Cumulative DOM bid is the sum of all the available DOM bid volumes and cumulative DOM ask is the sum of all the available DOM ask volumes. 404 shows the cumulative bid DOM calculation and 405 shows the cumulative ask DOM calculation. As one or more bid and/or ask DOM volumes change so will change the cumulative values of DOM bids and/or ask.

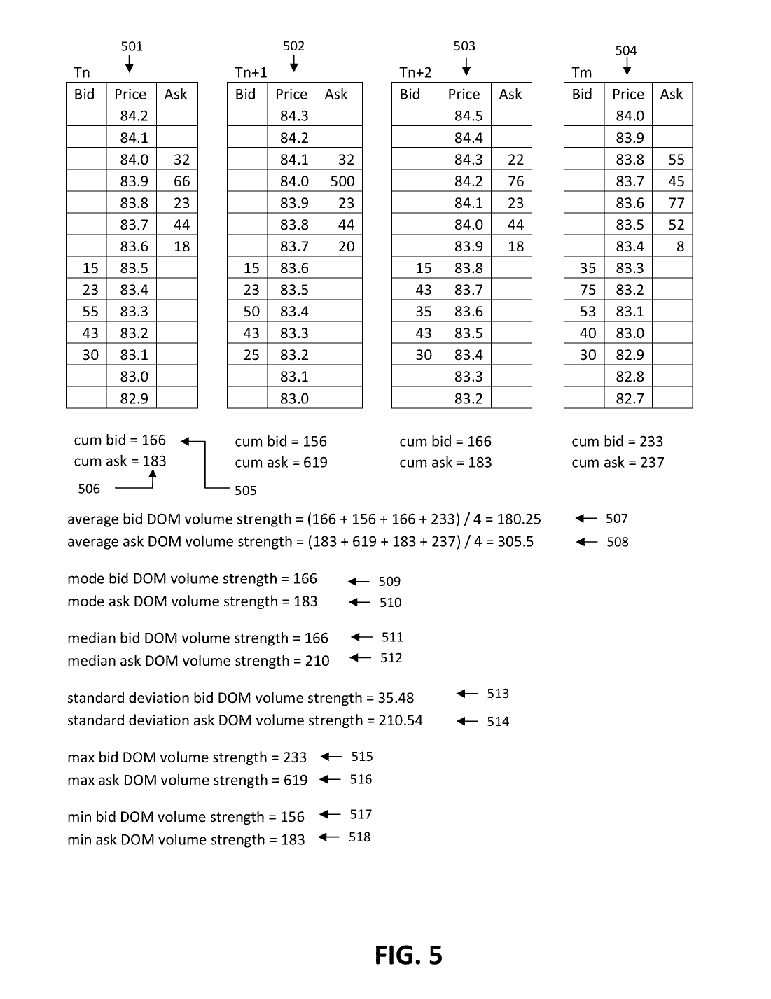

FIG. 5 illustrates examples of DOM volume strength computations in accordance with one or more embodiments. In this example five DOM levels of each ask and bid are displayed. Typically numbers of DOM levels vary by exchange and instrument. For example shows exemplary DOM tables representing snapshots over the determined time period such as the duration of one candlestick bar. Typically each bar has a beginning and end time period. In this example the bar start time is Tn and end time is Tm. 501 snapshot represents the beginning of the bar at time Tn, 502 and 503 represent the DOM snapshot while the bar is in progress at times Tn+1 and Tn+2, and 504 is the ending of the bar at time Tm snapshot. Typically DOM goes through various changes during a bar duration but for illustrative proposes only four snapshots are shown. 505 is the cumulative bid DOM for 501 table and 506 is the cumulative ask DOM for 501 table, similarly cumulative bid and ask DOM values are shown below 502, 503 and 504 DOM tables respectively. Cumulative values are calculated as shown in FIG. 4 for example 505 is calculated by adding bid column values of 501 for example 166=15+23+55+43+30 and 506 is calculated by adding ask columns values of 501 for example 183=32+66+23+44+18. DOM volume strength can be calculated in many ways but not limited to from the cumulative values during the bar duration for example average DOM volume strength for the duration of a bar and is calculated by summing all the cumulative values divided by total number of cumulative values over the duration of each bar for example 507 is the average bid DOM volume strength calculated by summing cumulative bids from 501, 502, 503 and 504 and dividing by four since this example only shows four snapshots. The value of 507 is computed as (166+156+166+233)/4=180.25 and similarly value of 508 is computed as (183+619+183+237)/4=305.5. 509 is another way of computing the DOM volume strength by taking the mode of all the DOM values over the duration of each bar. 509 is the mode bid DOM volume strength and is calculated by computing the mode of cumulative bid DOM volumes of 501, 502, 503 and 504 for example 166 value of 509 is mode value of 166, 156, 166 and 233 set and similarly 183 value of 510 is mode value of 183, 619,183 and 237 set. 511 is the median bid DOM volume strength and is calculated by computing the median of cumulative bid DOM volumes of 501, 502, 503 and 504 for example 166 value of 511 is median value of 166, 156, 166 and 233 set and similarly 210 value of 512 is median value of 183, 619,183 and 237 set. 513 is the standard deviation bid DOM volume strength and is calculated by computing the standard deviation of cumulative bid DOM volumes of 501, 502, 503 and 504 for example 35.48 value of 513 is standard deviation value of 166, 156, 166 and 233 set and similarly 210.54 value of 514 is standard deviation value of 183, 619,183 and 237 set. 515 is the maximum bid DOM volume strength and is calculated by computing the maximum of cumulative bid DOM volumes of 501, 502, 503 and 504 for example 233 value of 515 is maximum value of 166, 156, 166 and 233 set and similarly 619 value of 516 is maximum value of 183, 619, 183 and 237 set. 517 is the minimum bid DOM volume strength and is calculated by computing the minimum of cumulative bid DOM volumes of 501, 502, 503 and 504 for example 156 value of 517 is minimum value of 166, 156, 166 and 233 set and similarly 183 value of 518 is minimum value of 183, 619,183 and 237 set.

While in present example DOM volume strength is measured in various ways such as average, mode, median, standard deviation, maximum and minimum, it will be understood by those of ordinary skill in art that various changes in forms, details and/or statistics may be made therein without departing from the spirit and scope of present invention.

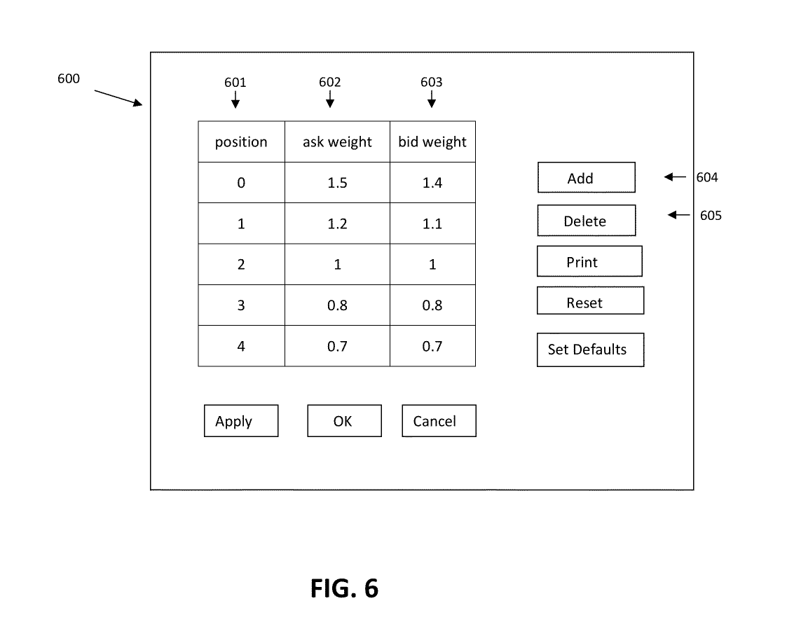

In FIG. 6 600 illustrates exemplary user interface that allow user to configure optional weight parameters for use in measuring DOM volume strength in one embodiment of FIG. 5. According to the illustrated embodiment, a user configurable weight table enables user to specify weight 602 and 603 for each position 601 of price level from inside market for example in FIG. 4, the price level that lies directly between the highest price bid (here, 79.9) and the lowest ask price (here, 80.0) is the “inside market” price, which may or may not be a valid tradable market price. In this example the position closest to inside market price is considered position 0, for bids the position numbers increases for every price level below for example in FIG. 4 for price level 79.8 the bid value 50 is considered to be at position 1, for asks the position numbers increases for every price level above for example in FIG. 4 for price level 80.1 the ask value 15 is considered to be at position 1 and so on. It will be understood by those of ordinary skill in art that it is not necessary to start position numbering from 0. Since levels of DOM data may vary by exchange and instrument 604 enables user to add additional DOM levels and 605 enables user to delete some DOM levels.

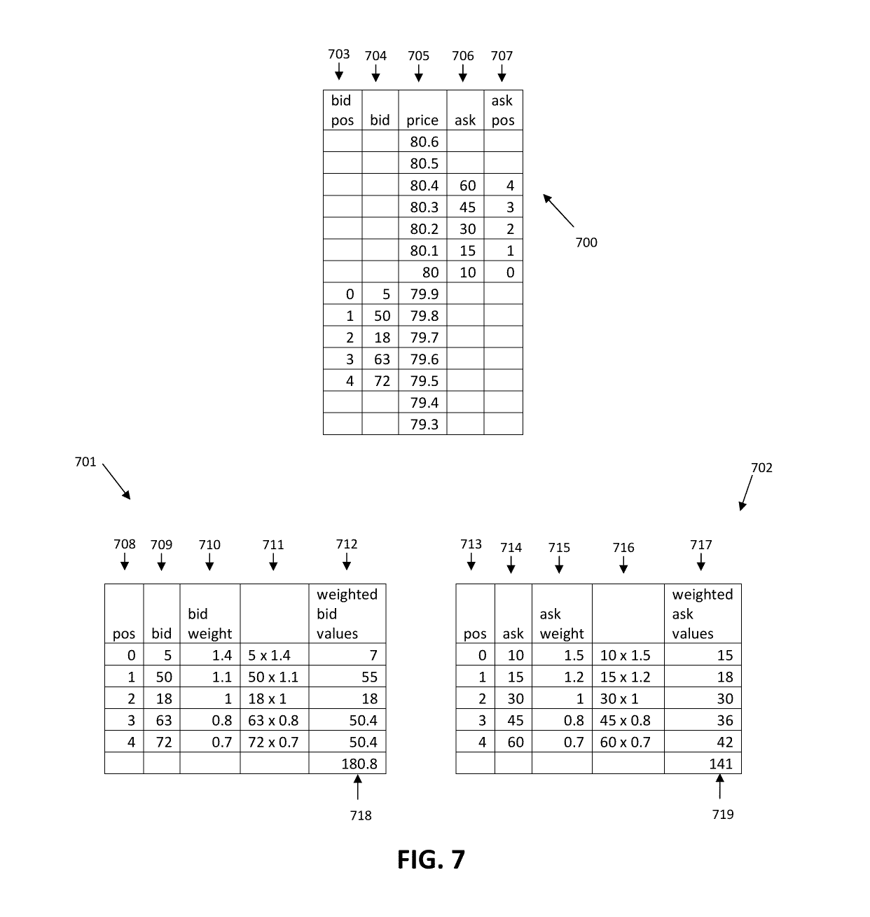

FIG. 7 illustrates another way of calculating cumulative DOM volumes by using user configurable weights. 700 displays' a snapshot of DOM at a certain time with five levels each of ask and bid volume data. 703 (bid position column) is used to show the position number of each bid volume on 704 and 707 (ask position column) is used to show the position number of each ask volume on 706. 701 shows calculations for weighted bid volumes. 708 shows bid positions from 703 and 709 shows the corresponding bid volumes from 704. 710 is the user configurable bid weight as explained in FIG. 6. 712 is the weighted bid volumes. 718 is the weighted cumulative bid volume, which may be further used instead of just cumulative bid volume as shown in FIG. 5. 702 shows calculations for weighted ask volumes. 713 shows ask positions from 707 and 714 show the corresponding ask volumes from 706. 715 is the user configurable ask weight as explained in FIG. 6. 717 is the weighted ask volumes. 719 is the weighted cumulative ask volume, which may be further used instead of just cumulative ask volume as shown in FIG. 5.

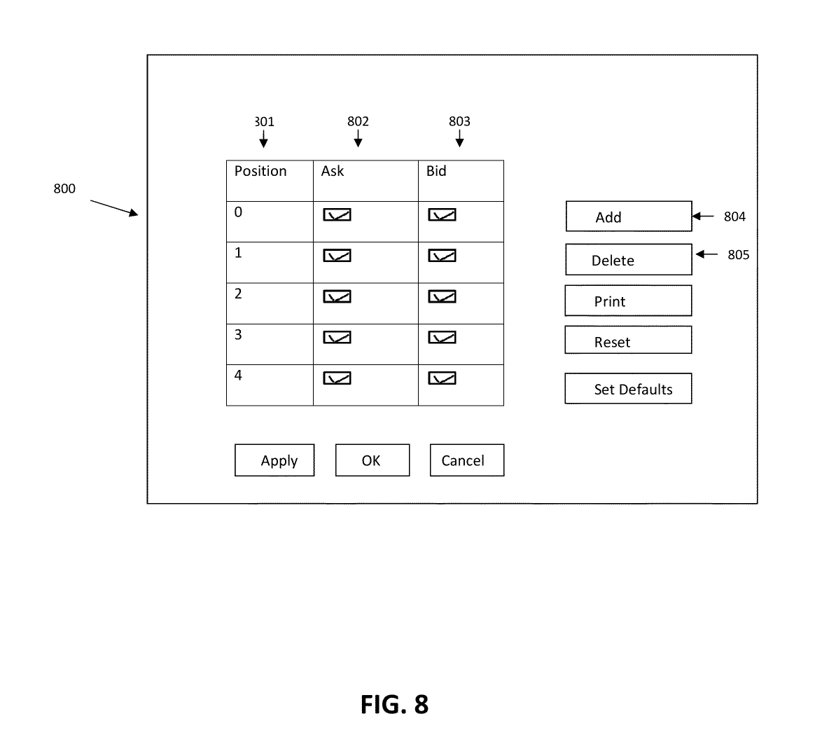

FIG. 8 illustrates exemplary user interface that allow user to select the available DOM levels for use in measuring DOM volume strength according to one embodiment of the present invention. Typically number of DOM levels provided varies by exchange and instrument. 800 displays an exemplary user interface where user can select DOM levels (by checking the checkbox) from the exchange provided DOM levels. 801 shows the position of ask and bid DOM volume level from inside market as explain earlier in FIG. 7. 802 shows checkbox's to select ask DOM volume level corresponding to position number. 803 shows checkbox's to select bid DOM volume level corresponding to position number. As shown in FIG. 8 user has selected five levels each for ask and bid DOM. 804 allows user to add a row if more DOM levels are provided by exchange, similarly 805 allows user to delete a row. These selected levels may then be used for calculating cumulative DOM volumes as shown in FIG. 5.

In FIG. 9.1, 900 illustrates exemplary user interface that allow user to select/unselect alerts if the user configurable min and/or max percent rank of DOM volume strength are reached according to one embodiment of the present invention. The user may set the values in 901 and turn on/off the alerts using 902. Alerts may be sound cues and/or tones are emitted as “echoic” and/or audible trading indications and/or any visual indications such as arrows on the bar chart above/below the bars on which a specified condition was reached.

In FIG. 9.2, 903 illustrates exemplary user interface that allow user to select/unselect alerts if the user configurable min and/or max absolute values of DOM volume strength are reached according to one embodiment of the present invention. The user may set the values in 904 and turn on/off the alerts using 905. Alerts may be sound cues and/or tones are emitted as “echoic” and/or audible trading indications and/or any visual indications such as arrows on the bar chart above/below the bars on which a specified condition was reached.

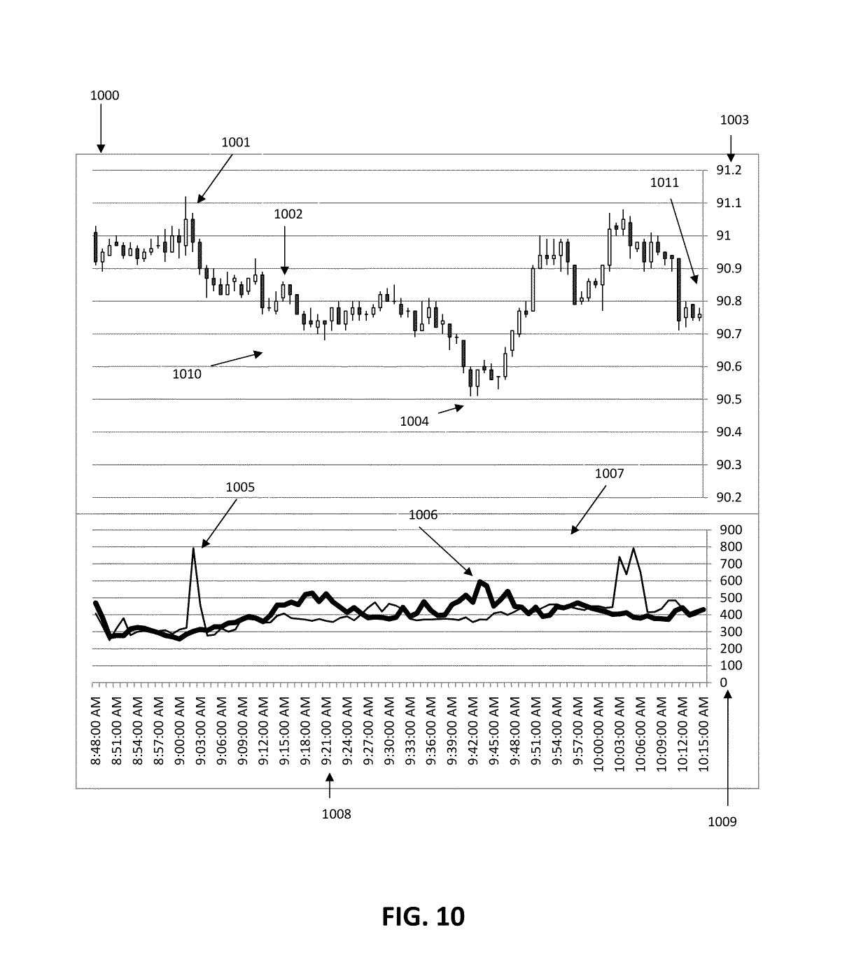

FIG. 10 illustrates an exemplary DOM volume strength indicator in correspondence with candlestick chart, in accordance with various embodiments of the present invention. FIG. 10 is a snapshot of a graphical user interface 1000 for trading of financial instruments in accordance with one embodiment. Because FIG. 10 is a snapshot, it illustrates information for one selected financial instrument at a particular instant in time. The values shown in FIG. 10 are for illustrative purposes only. In actual operation, the user can select a different financial instrument and the information in the user interface 1000 will be substantially continuously updated as streaming data are received by the client application. Typically each bar or candle such as 1002 in candlestick chart acts as a data point which includes one or more data values such as, but not limited to, a start time, an open price, a high price, a low price, a close price. Each bar corresponds to finite time duration during a trading session or trading sessions. For illustrative purpose, in this example white body as in 1002 means the bar close above its open and black body as in 1001 means the bar closed below its open. The candlestick chart is aligned with price scale 1003. The candlestick chart 1010 includes a plurality of bars 1002 that reflect various financial information at associated times shown in a horizontal axis time scale 1008. Times on the time scale 1008 go from youngest (most recent) on the right side of the bar chart 1010 to oldest (least recent) on the left side of the bar chart 1010. Thus, when a new bar is created, such as bar 1011, it is displayed on the right side of the bar chart 1010, with all the other bars shifting to the left, and the leftmost bar disappearing from the display. Displaying bars such as 1002 are available in many commercial applications. 1007 is an example, of an average cumulative ask and bid DOM volume strength indicator, corresponding to each bar in 1010.The average indicator is for illustrative purposes only as the indicator may be based on average, mode, median, max, min standard deviation and much more. 1007 consist of two line charts, 1005 corresponds to average ask DOM volume strength and 1006 corresponds to average bid DOM volume strength at associated times shown in a horizontal axis time scale 1008. 1009 number scale indicates the actual value of the average ask and bid DOM volume strength. One key advantage of using cumulative ask and bid values instead of their difference is it assist trader in identifying support and resistance levels/zones, for example 1005 has highest value of around 800 for average cumulative ask DOM volume which corresponds with 1001 on candlestick chart, in this example the price level of 1001 acted as a resistance and the price of the financial instrument traded moved lower, similarly 1006 has highest value of around 600 for average cumulative bid DOM volume which corresponds with 1004 on candlestick chart, in this example the price level of 1004 acted as a support and the price of the financial instrument traded moved higher. Typically price action is known to either reverse or break down/up at or near support and resistance levels. This present invention may assists trader in identifying the support and resistance levels while they are been formed and not on historical price action such as pivots and more as mentioned in many known trading articles and books. This early identification improves trader's ability to make informed decisions and profit in the market.

Although the candlestick chart 1010 and the DOM volume strength indicator 1007 are illustrated together in the display 1000, it will be understood by those skilled in the art that these charts can be presented separately or in any combination with or without additional indicators. Also DOM volume strength values can be presented in different ways such as variable bar widths and/or histograms and or different colors combinations and/or intensities and/or different style charts/indicators and much more to convey information to the user.

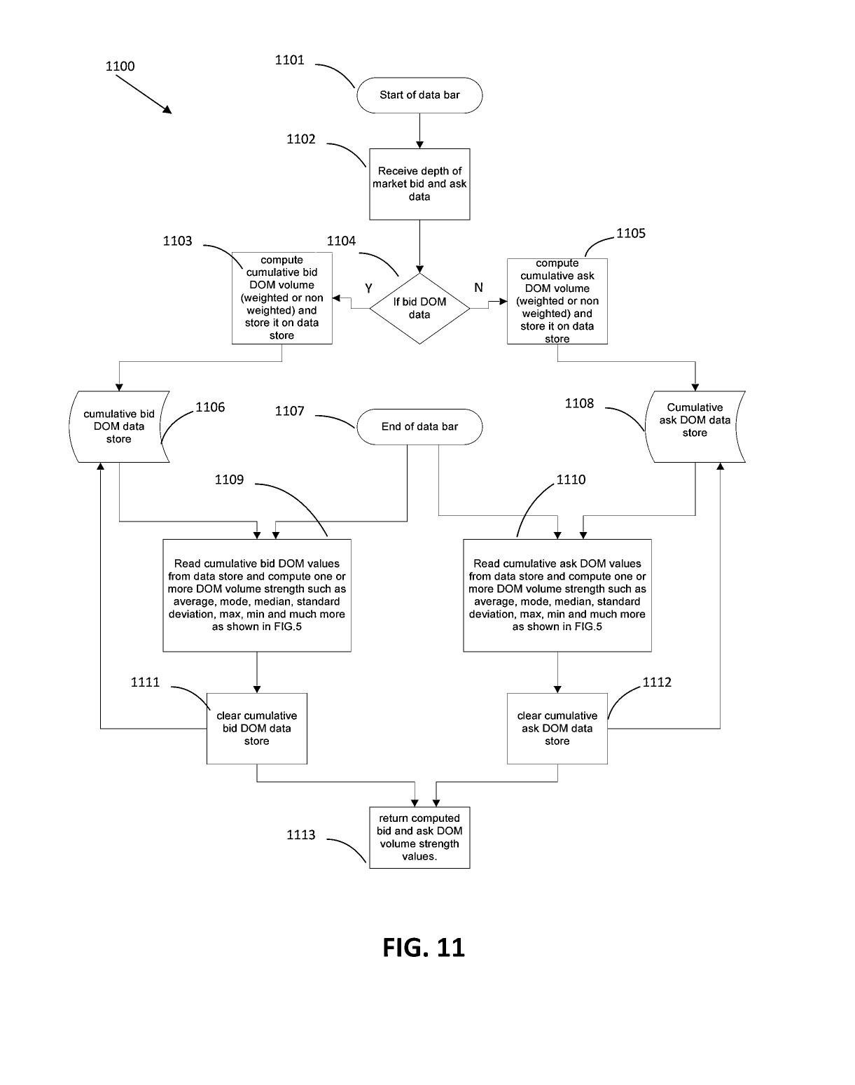

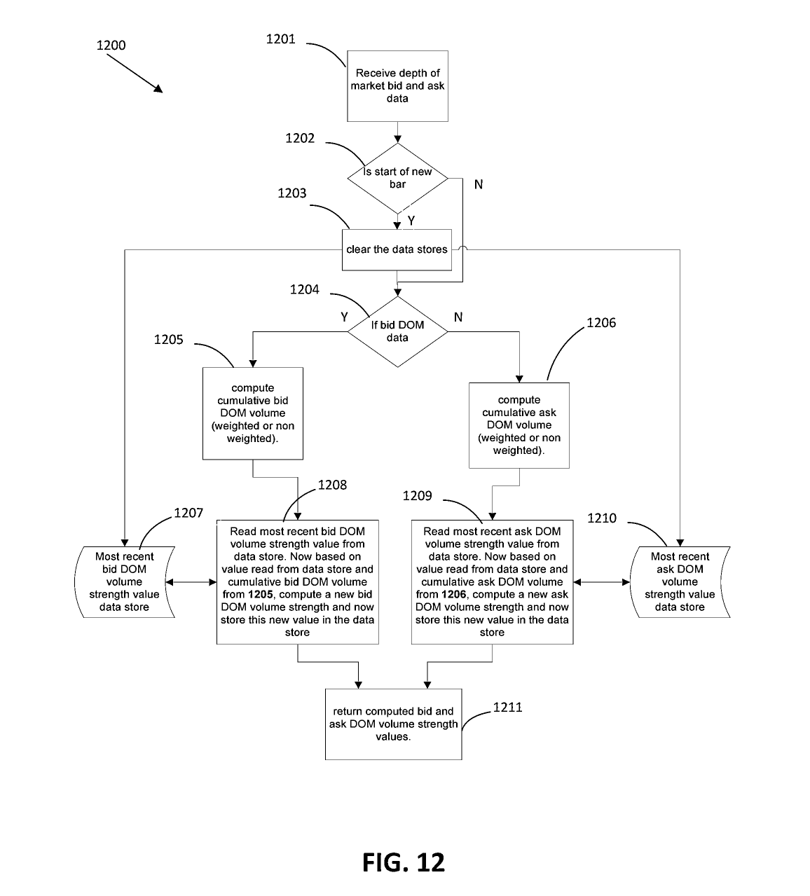

FIG. 11 and FIG. 12 are flowcharts illustrating exemplary algorithms for generating DOM volume strength values using real-time DOM market information, in other embodiments the values may be generated using historical DOM market information.

FIG. 11 is a flowchart illustrating an algorithm 1100 for calculating the DOM volume strength values for a current bar in accordance with one embodiment of the present invention. For illustrative purposes only let's assume that user has selected a bar chart type say minute based bar chart in which every bar has a start and end time period. The algorithm 1100 repeats for each bar. In this exemplary algorithm the start 1101 and end 1107 of each bar is captured. DOM ask and bid data 1102 is received continuously. 1104 checks if the data received is for bid or ask. If bid DOM data is received then 1104 branches to 1103 where cumulative bid DOM volume (weighted or non-weighted) is computed and stored(pushed) on data store 1106. If ask DOM data is received then 1104 branches to 1105 where cumulative ask DOM volume (weighted or non-weighted) is computed and stored(pushed) on data store 1108. 1106 and 1108 data stores that hold all the values stored (pushed) in it until the data stores are cleared as in 1111 and 1112. When end of data bar 1107 is triggered, in 1109 cumulative bid DOM values are read from data store 1106 and one or more DOM volume strength indicators are calculated such as average, mode, median, standard deviation, max, min and much more as shown in FIG. 5, similarly in 1110 cumulative ask DOM values are read from data store 1108 and one or more DOM volume strength indicators are calculated such as average, mode, median, standard deviation, max, min and much more as shown in FIG. 5. The data stores 1106 and 1108 are then cleared (all existing values stored/pushed by 1103 and 1105 are erased) as in 1111 and 1112. The computed bid and ask DOM volume strength values are then returned as in 1113. Furthermore efficient means could be applied to compute certain values such as for example computing average cumulative bid/ask values, instead of pushing (saving) each cumulative value on data store and then reading all values to compute the average, the running total of cumulative values and total number representing those values could be saved on the data store, these values in turn could be used to compute average cumulative bid/ask values. As an alternative embodiment if it is not possible to get an end of bar signal as in 1107 and instead only start of new bar signal is available then the computations done at 1107 may be done at the beginning of new bar start.

FIG. 12 illustrates an algorithm 1200 for calculating the DOM volume strength values in accordance with an alternative exemplary embodiment. In this particular embodiment, there is no end of bar signal, only start of the bar signal is available and the bid and ask DOM volume strength values are computed on continuous basis while the bar is in progress instead of computations on end of bar as per the 1100 algorithm in FIG. 11. Algorithm 1200 is repeated for each change in DOM data. DOM ask and bid data 1201 is received continuously. 1202 checks if the data received is part of new bar, if yes then data stores 1207 and 1210 are cleared (all existing values stored/pushed by 1208 and 1209 are erased) and proceed to 1204 where incoming DOM data is checked if it is a bid or ask data. If bid data in 1204 then compute cumulative bid DOM volume (weighted or non-weighted) as in 1205. In 1208 read most recent bid DOM volume strength value from data store 1207 and cumulative bid DOM volume from 1205, based on values from 1205 and 1207 compute new bid DOM volume strength value. Return this new value as in 1211 and also store this new value in the data store 1207. If ask data in 1204 then compute cumulative ask DOM volume (weighted or non-weighted) as in 1206. In 1209 read most recent ask DOM volume strength value from data store 1210 and cumulative ask DOM volume from 1206, based on values from 1206 and 1210 compute new ask DOM volume strength value. Return this new value as in 1211 and also store this new value in the data store 1210. Based on the computations in 1208 and 1209 one or more DOM volume strength indicators are calculated such as average, mode, median, standard deviation, max, min and much more as shown in FIG. 5

While FIG. 11 and FIG. 12 are flowcharts illustrating exemplary algorithms for generating DOM volume strength values, it will be understood by those of ordinary skill in art that various changes in forms, details and/or flow may be made therein without departing from the spirit and scope of present invention.

If the specifications or illustrations states a component or feature “may”, “can”, “could” or “might” be included or have a characteristics, that particular component or feature is not required to be included or have the characteristics.

It should be understood that the above description of the invention and specific examples and embodiments, while indicating the preferred embodiments of the present invention are given by demonstration and not limitation. Many changes and modifications within the scope of the present invention may be made without departing from the spirit thereof and the present invention includes all such changes and modifications.

1. A method for generating a depth of market (DOM) volume strength, the method compromising:
monitoring DOM volume of a financial instrument,
wherein the DOM volume includes bid volume elements and ask volume elements corresponding to price levels for electronically traded financial instruments;
computing bid DOM volume strength and ask DOM volume strength by evaluating functions of DOM volume;
notifying alerts based on the computed bid DOM volume strength and ask DOM volume strength; and
displaying indicators based on the computed bid DOM volume strength and ask DOM volume strength values.

2. The method of claim 1, wherein monitoring DOM volume compromises:
monitoring all the DOM levels provided by exchange for the financial instrument or only selected levels based on user configuration.

3. The method of claim 1, wherein computing functions of DOM volume compromises:
creating data stores for populating cumulative bid DOM volume and cumulative ask DOM volume.
between start time and end time, for every change in the DOM data, calculate cumulative bid volume and cumulative ask volume and populate these values on the respective data stores.
at the end time read all the cumulative bid and cumulative ask volume values from the respective data stores and compute bid DOM volume strength and ask DOM volume strength by using either one or more functions such as average, mode, median, standard deviation, maximum and minimum and the like. Also at the end time clear the data stores.

4. The method of claim 3, wherein the cumulative bid DOM volume and cumulative ask DOM volume may be calculated by including user configurable weights for each DOM level or weights may be optional.

5. The method of claim 3, wherein a start time could be a start time of a bar on a bar chart with plurality of bars and end time could be end time of that bar on a bar chart with plurality of bars.

6. The method of claim 3, wherein cumulative bid volume and cumulative ask volume can be calculated for every change in the DOM data or at a user configurable frequency.

7. The method of claim 3, wherein DOM volume strength values can be computed at the end of each bar on a bar chart with plurality of bars.

8. The method of claim 1, wherein notifying alerts based on the computed DOM volume strength compromises:
generating user configurable alerts based on percentage rank or absolute values of DOM volume strength.

9. The method of claim 8, wherein alerts can be notified by auditory cues or visually displaying arrows colored or non-colored, above or below a bar on a bar chart and pointing in up or down direction.

10. The method of claim 1, wherein displaying indicators based on the computed DOM volume strength compromises:
Displaying a bar chart with plurality of bars; and
locating the indicators of the computed DOM volume strength above, below or overlaid on the plurality bars.

11. The method of claim 10, wherein the indicators are bid and ask DOM volume strength values displayed in one or more technical analysis format such as line chart, histogram chart and the like.

12. The method of claim 1, wherein displaying indicators based on the computed DOM volume strength further compromises:
Displaying a bar chart with plurality of bars;
Each bar may be vertically divided and the width of the each side of the divider can be variable based on bid DOM volume strength and ask DOM volume strength values respectively.

13. The method of claim 12, wherein the bar divider can be a dotted line or can be of any style, color or shape as long as it clearly displays the bar divided in two vertical sections.

14. The method of claim 1, wherein computing functions of DOM volume further compromises:
creating a data stores for populating bid DOM volume strength and ask DOM volume strength values.
between start time of each bar for every change in the DOM data calculate cumulative bid DOM volume and cumulative ask DOM volume. Based on these calculated cumulative bid and ask DOM volumes and most recent bid DOM volume strength and ask DOM volume strength values from the data stores compute new bid DOM volume strength and ask DOM volume strength values and store these new values on the data stores.
At the start of each new bar also clear the data stores.

15. The method of claim 14, wherein a start time could be a start time of a bar on a bar chart with plurality of bars.

16. The method of claim 14, wherein computations on DOM volume can be done for every change in the DOM data or at a user configurable frequency.

17. The method of claim 14, wherein DOM volume strength can be computed on real-time basis instead of computations done at the end of each bar on a bar chart with plurality of bars.

18. A apparatus for trading financial instruments on an electronic exchange, the apparatus compromising:
computer based systems or electronic terminals and the like for trading financial instruments on an electronic exchange.
